(19) United States
(12) Patent Application Publication
(10) Pub. No.: US 2020/0038697 A1
(43) Pub. Date: Feb. 6, 2020

(54) SYSTEM AND A METHOD FOR MONITORING ENGINE CONDITIONS

(71) Applicants: Roland E. GALBREATH, (US); Kevin RUSSELL, (US)

(72) Inventors: Roland E. GALBREATH, Cadiz, KY (US); Kevin RUSSELL, Melbourne, FL (US)

(73) Assignee: Telesafe LLC, Cadiz, KY (US)

(21) Appl. No.: 16/360,268

(22) Filed: Mar. 21, 2019

Related U.S. Application Data
(60) Provisional application No. 62/712,375, filed on Jul. 31, 2018.
(60) Provisional application No. 62/743,684, filed on Oct. 10, 2018.

(51) Int. Cl. A62C 3/10; G08B 17/117

(52) U.S. Cl. CPC A62C 3/10; G08B 17/117

(57) ABSTRACT

A system and a method for preventing a boat fire. Such a system and method may sense fumes in an engine of a boat (or other system that includes an engine), alert the boat operator and inhibit the engine or engines from starting. Also, the system and method allow for a bypass of the system in the event of false alarm and warn with alarm prior to expiration of the life time for fume sensors. Further, in a case where an onboard generator is used in boats, the system and method shutdown the generator upon a signal from a carbon monoxide detector providing immediate cessation of carbon monoxide producer.

### CROSS REFERENCE TO RELATED APPLICATIONS

This application claims priority from U.S. Provisional Patent Application Ser. No. 62/712,375, filed Jul. 31, 2018 and U.S. Provisional Patent Application Ser. No. 62/743,684, filed Oct. 10, 2018, the entire contents of which are hereby incorporated by reference.

### BACKGROUND

Many states in the United States require a boater education, typically a “Boaters Safety Course”. However, the safety courses usually do not cover practical matters such as engine fumes, blowers, or how to properly fuel a boat. Studies reveal that the majority of fires in boats start in a few very specific places aboard the boat, with a significant number of them originating in the engine compartment where fuel and an ignition source have a high likelihood of coming together. However, many inexperienced boat buyers and owners do not know how to maintain the engine and related systems of boats. For example, they are not aware that even if they have a gasoline fume warning system, the sensors have a limited life expectancy, for example, 4-years. Using automobile starters, alternators, or etc. as replacements for “Marine Grade Arc Fault Protection”, the parts are another under reported problems.

As a result, numerous hazardous situations related to storing, starting, and operating boats exist. Further, as similar concerns with other types of engines, such as those used with generators and recreational vehicles, hazardous situations exist there as well.

### SUMMARY

A system and a method for monitoring any of a variety of vehicles, engines or generators, as well as residential and commercial applications, may be shown and described. According to an exemplary embodiment, such a system and method may sense undesired levels of various gas or liquid whose leakage from such engines or applications may cause dangerous or hazardous results, alert the operator of the hazardous situation via visual or audible indicators and interfaces wired or wirelessly connected through private area networks, and inhibit the engines or the applications from receiving the electric power required to start up.

Such a system may include: one or more power controllers having a first electronical connection to a first power source; one or more starter controllers having a second electronical connection to one or more starters; one or more sensors which detect at least one of gas and liquid; and a control panel.

In another exemplary embodiment, a method for monitoring engine conditions may be described. Such a method may include: having a first electronical connection, by one or more power controllers, to a first power source; having a second electronical connection, by one or more starter controllers, to one or more starters; detecting gas and/or liquid by one or more sensors; and displaying, by a control panel, the detection of the sensor.

In another exemplary embodiment, a portable device for monitoring engine conditions may be described. Such a device may include: a sensor detecting at least one of gas and liquid; an operating unit having a visual indicator and an audible indicator; a power source supplying a power to the sensor and the operating unit; and a connector operably connecting the sensor and the operating unit.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 is an exemplary schematic diagram showing a system of gasoline fume sensing for an engine.

FIG. 2 is an exemplary schematic diagram showing a system of gasoline fume sensing for one engine and carbon monoxide sensing for a generator.

FIG. 3 shows an exemplary circuit diagram of a power controller as a first power source is energized.

FIG. 4 shows an exemplary circuit diagram of a power controller as a second power source is energized.

FIG. 5 shows an exemplary circuit diagram of a starter controller.

FIG. 6 is an exemplary schematic diagram showing a control panel of the system.

FIG. 7 is an exemplary schematic diagram showing a control panel face of the system.

FIG. 8 is an exemplary schematic diagram showing a control panel of the system being wirelessly connected to an interface and sensors.

FIG. 9 is an exemplary schematic diagram showing an interface of the system.

FIG. 10 is an exemplary schematic diagram showing an interface of the system being wirelessly connected to a control panel and to a private area network which extends the connection to different kinds of devices.

FIG. 11 is an exemplary schematic diagram showing a private area network of the system being used to connect the interface and various devices, and to connect sensors and a control panel.

FIG. 12 is an exemplary schematic diagram showing a portable instrument for monitoring engine conditions.

FIG. 13 is an exemplary schematic diagram showing an operating unit's face.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

According to an exemplary embodiment, and referring to the Figures generally, a system and a method for preventing a boat fire, or a fire in any of a variety of other vehicles, may be shown and described. According to an exemplary embodiment, such a system and method may sense potentially hazardous or harmful fumes in an engine of a boat, generator, recreational vehicle, or other vehicle, alert the operator, and inhibit engines from starting in an “alarm” mode. Also, in an exemplary embodiment, the system and method may allow Bypass Switch Input of the system in the event of false alarm and may warn with alarm prior to expiration of the life time for fume sensors, for example, 30 days in advance (or some other time period, as desired). Further, in a case where an onboard generator is used in vehicles, the system and method may shutdown the generator upon a signal from a carbon monoxide sensor providing immediate cessation of carbon monoxide producer. Here, the producer may include any kind of engine or generator which produces any undesired kind of or harmful gas or liquid. The system may also warn via a control panel and an interface in visual and audible form, prior to expiration of the life time for the sensors, for example, 30 days in advance.

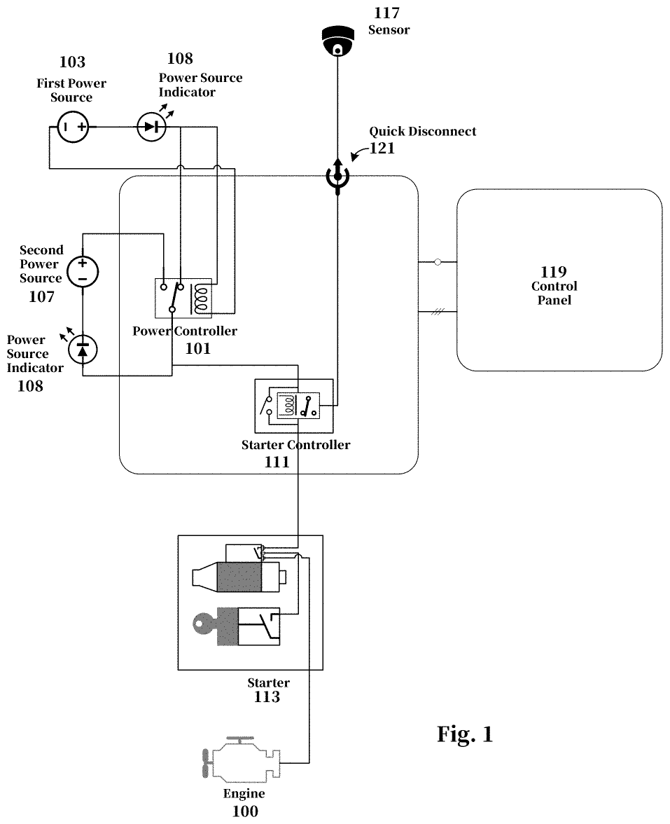

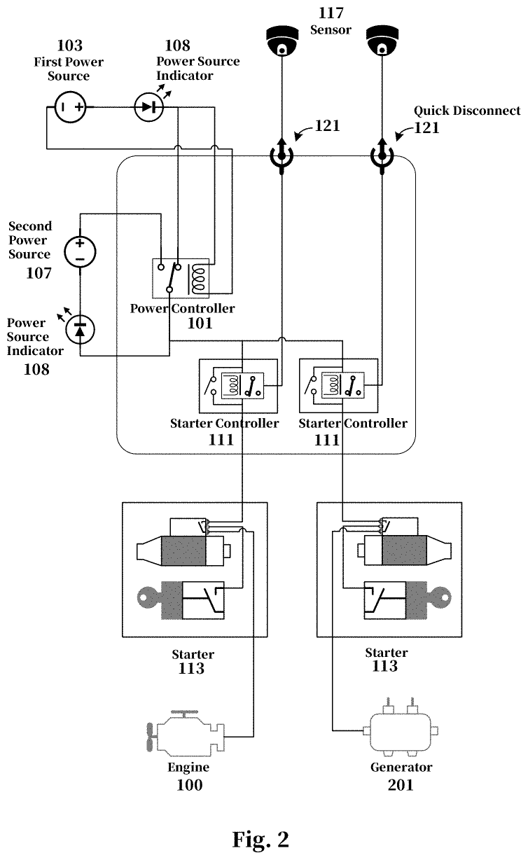

Turning now to exemplary FIGS. 1 and 2, an exemplary schematic diagram of the system of sensing an undesired kind of gas from engines may be shown and described. Additionally, although exemplary embodiments may refer generally to boats, boat engines, and boat fires, it will be appreciated that exemplary embodiments of the system may be implemented and utilized with any other desired vehicle, such as, but not limited to, recreation vehicles, as well as other engines, such as, but not limited to, generators. According to an exemplary embodiment, the system for preventing a boat fire may be configured for any cases where the vehicle has a single engine 100 or multiple engines 100. For example, for a single engine 100, the system may include a gasoline and/or hydrocarbons fume sensor 117 and a starter controller 111. In a case where the boat has a generator 201, the system may further include a second gasoline, hydrocarbons fume and/or carbon monoxide sensor 117, and a second starter controller 111. Also, in an exemplary embodiment, the system may be connected to the first power source 103, for example 12V DC. In a case where there are two separate battery banks, the first and the second power sources 103, 107 may be connected to one of each on opposite banks. In an exemplary embodiment, the second power source 107 may be connected to the starter 113 that is on opposite bank of the first power source 103.

Still referring to exemplary FIGS. 1 and 2, the system for the generator 201 may also include a gasoline and/or hydrocarbons fume sensor 117 and a starter 113. The second power source 107 may be connected to the starter 113 and landed on starter 113's positive post (fused). According to an exemplary embodiment, even though there is only one battery bank, it is less likely that the both connections to the first power source 103 and the second power source 107 are simultaneously damaged or both fuses 301 are blown in comparison with conventional systems which have no alternative power cables. In the event there are two separate battery banks, it needs to be ensured that the first and the second power sources 103, 107 are connected to one of each on opposite banks. The second power source 107 may be connected to the starter 113 that is on opposite bank of the first power source 103.

Further, in such systems as shown in exemplary FIGS. 1 and 2, the conditions for a sensor 117 to send a signal to a starter controller 111 in the system may require sensing fume or less than 25% of combustion and the sensor 117 and a control panel 119 may delineate whether the sensor 117 is sending the detecting signal for gas or hydrocarbon gases from batteries. In this case, the starter controller 111 may be de-energized after receiving a 12V DC signal, opening the closed contacts going to the starter 113 circuit. In this condition, where the starter controller 111 is de-energized, the system may be silenced, but until fumes are eradicated, the starter controller 111 may keep being de-energized.

In still further exemplary embodiments, the system may be configured for a case where there is a generator 201. In an exemplary embodiment, the system may monitor, alert and inhibit the starter of the generator 201 in the event of sensing gasoline fumes and/or carbon monoxide, or less than 25% of combustion, and the system may delineate whether the sensor 117 is sending the signal for gasoline fumes or hydrocarbon gases from batteries, or carbon monoxide from the generator. According to an exemplary embodiment, the delineation is to ensure what causes the sensor 117 to send the signal. For example, when an operator receives an alarm, but does not smell gasoline fumes upon checking engine room, the validity of the system may be not questioned by the delineation. For example, conventional sensors are designed to “alarm” for gasoline fumes. However, the gases from both gasoline fumes and battery hydrocarbons are similar in makeup. Hence, the system may provide better confidence to the operator by additional sensing between gases. In an exemplary embodiment, the sensors 117 and a control panel 119 of the system may identify the kind of gas or liquid which caused the signal. According to an exemplary embodiment, the system for the generator 201 may include a carbon monoxide sensor 117 which may be installed within the engine room, and the system may open the generator's circuit in the event of carbon monoxide detection.

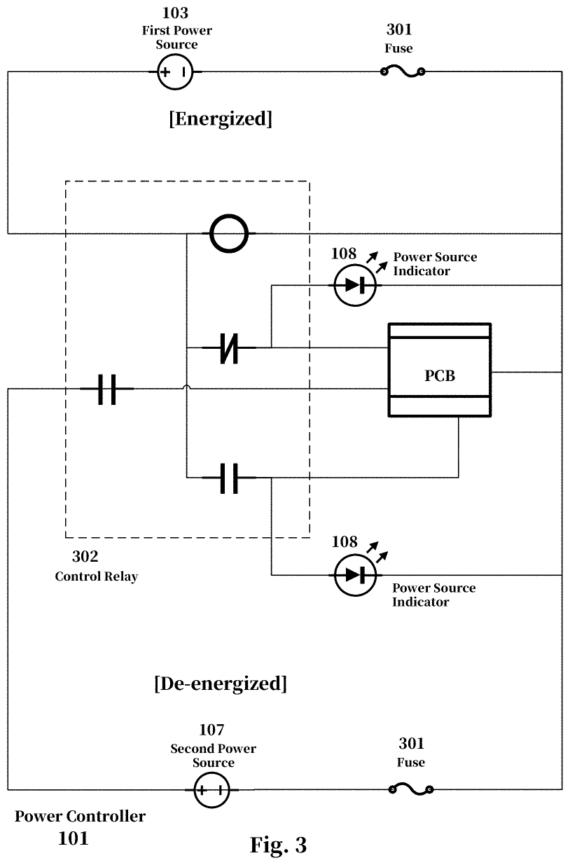

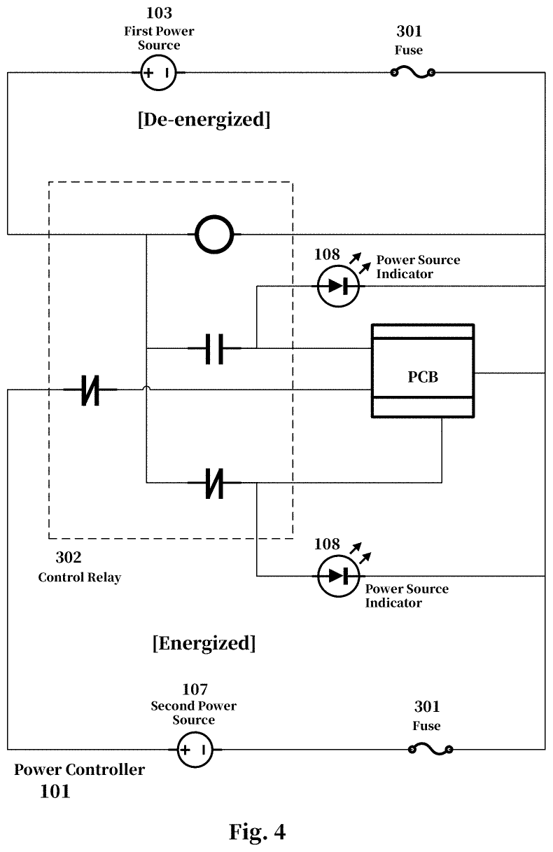

Turning now to exemplary FIGS. 3 and 4, an exemplary circuit diagram of the power controller 101 and the starter controller 113 may be shown and described. According to an exemplary embodiment, in the system, a fuse 301 may be installed in the circuit connected to the first power source 103 and in the circuit connected to the second power source 107. Also, in an exemplary embodiment, various colors of LEDs as the power source indicator 108 may be installed, for example, “Green” for the first power source 103 and “Red” for the second power source 107.

Still referring to exemplary FIGS. 3 and 4, the system may include a power controller 101, for example, 24V DC. In an exemplary embodiment, the power controller 101 may have a normally opened (NO) contact which has the NO contact from the first power source 103 in closed condition, and the power source indicator 108, “Green” LED illuminates. According to an exemplary embodiment, in the events of: Damage to the first power cable; Blown fuse on the first power source 103; and Coil goes bad on the power controller 101, a control relay 302 in the power controller 101 which contact from starter 113 may be open and connect the second power source 107 to the system. According to an exemplary embodiment, the system may also include a starter controller 111 which may open and close the starter 113 circuit for the engine 100 upon a signal from its designated sensor 117. For “failsafe” operation, the starter controller 111 may be energized as it is connected to the first power source 103 (NO: normally opened), and the NO contacts are closed to complete circuit to starter 113. In an exemplary embodiment, the starter controller 111 may also open and close the circuit for the engine 100, and for “failsafe” operation, the starter controller 111 may be energized as it is connected to the first power source 103.

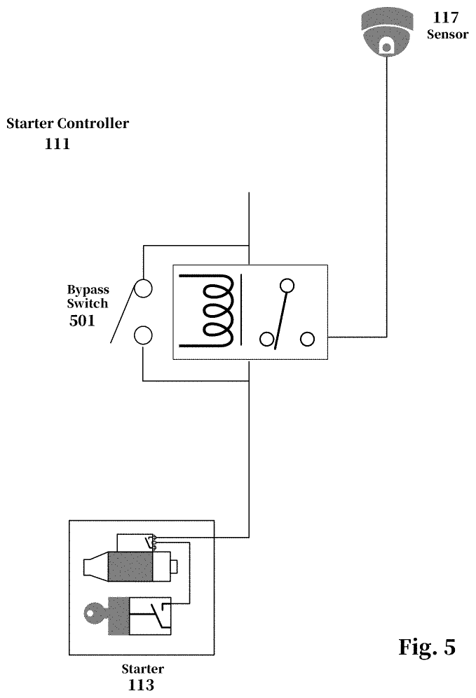

Turning now to exemplary FIG. 5, the system may include a starter controller 111. In an exemplary embodiment, the starter controller 111 may have a normally opened (NO) contact which has the NO contact to a starter 113 in closed condition. According to an exemplary embodiment, as the starter controller 111 receives a signal sent by a sensor 117 and/or a control panel 119 indicating that undesired or harmful gas or liquid reaches undesired level, the starter controller 111 may be de-energized. In this event, the starter controller 111 opens the closed contacts connected to the starter 113 circuit. In this condition, where the starter controller 111 is de-energized, the system may be silenced, but until fumes are eradicated, the starter controller 111 may remain de-energized. Also, in an exemplary embodiment, while the starter controller 111 is de-energized and the system may be silenced at the reception of the signal sent by the sensor, at an operator's manual request, a Bypass Switch 501 may be closed the opened contacts connected to starter 113 circuit after physical verification that there are no undesired kind of or harmful gas or liquid.

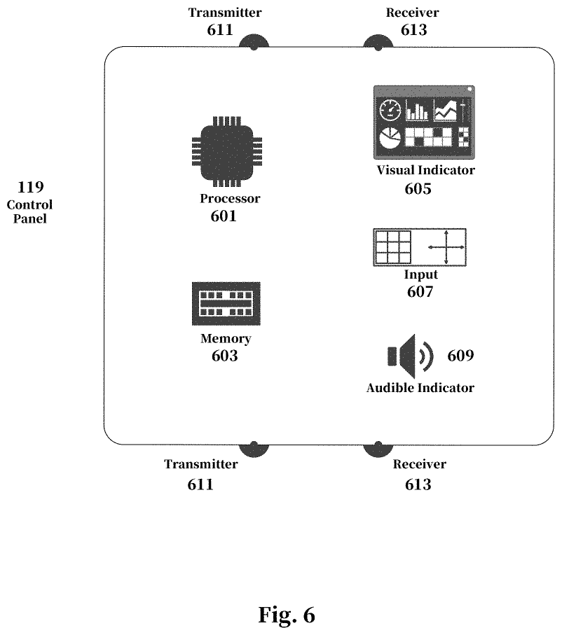

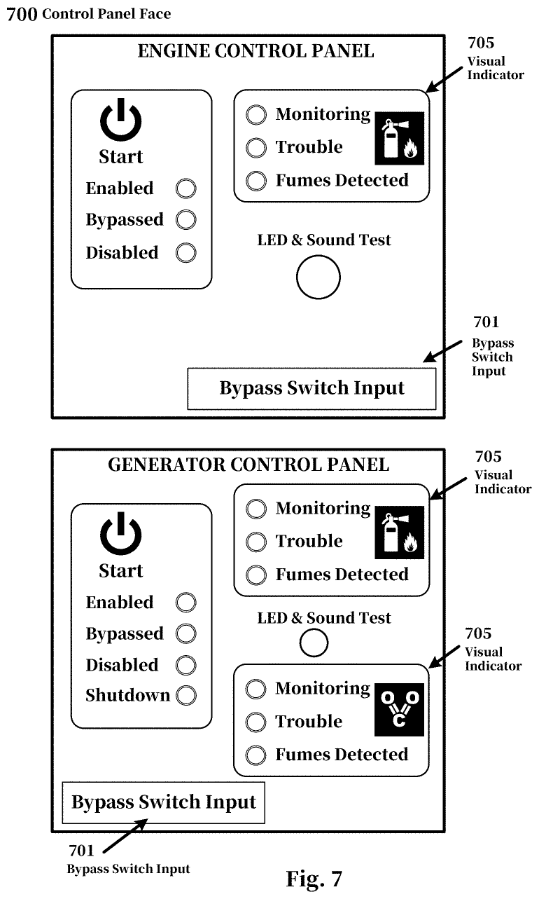

Turning now to exemplary FIGS. 6 and 7, an exemplary schematic diagram of a control panel 119 of the system may be described. According to an exemplary embodiment, in the event of that the system may be required to delineate whether the sensor 117 is sending the signal for gasoline fumes or hydrocarbon gases from batteries, or may be required to identify the kind of gas or liquid, the signal including various data from sensors 117 may be received via a receiver 613 and sent to a processor 601 in a control panel 119 to be analyzed by a corresponding set of computer instructions stored in memory 603. In this event, the results of the processor 601's computing may be indicated on a control panel face 700 for example, “Excessive Gasoline Fumes” or “Excessive Hydrocarbon Fumes.” Furthermore, the system may send trouble alerts by sending an signal to an audible indicator 609 and by indicating trouble conditions on a visual indicator 605, for example: Loss of the First Power Source 103; Loss of the Second Power Source 107; Cable to Sensors cut, or physical damage to sensor head; and End of Life of sensors 117 for example, 3 years 10 months upon energizing the system. Also, in an exemplary embodiment, the sensor cables may have quick disconnect 121 in order to avoid the need to replace the entire cable.

Still referring to exemplary FIGS. 6 and 7, in the event, where the starter controller 111 is de-energized at the reception of the signal sent by the sensor, an operator may use a Bypass Switch Input 701 to manually energize the starter controller 111 which is extended to the starter 113 circuit after physical verification that there are no undesired kind of or harmful gas or liquid. Further, in such systems as shown in exemplary FIGS. 6 and 7, the power source indicators 108 may be connected to a processor 601 or physically placed on a control panel face 700 in the system.

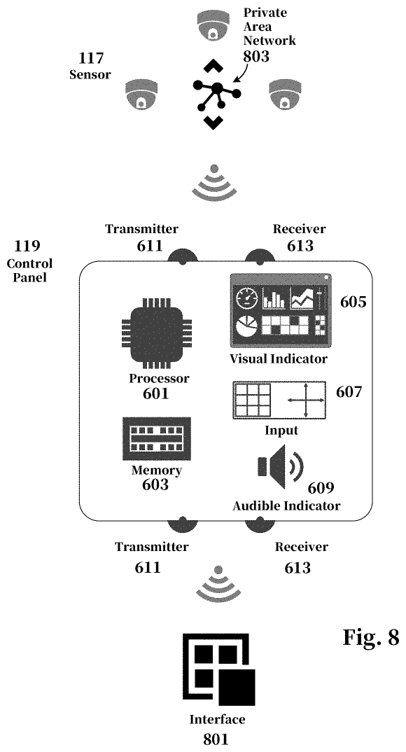

Turning now to exemplary FIG. 8, an exemplary embodiment of a control panel of the system being wirelessly connected to an interface 801 and sensors 117 may be shown and described. According to an embodiment, in the event of that the signal including various data from sensors 117 may be sent to a processor 601 in a control panel 119 to be analyzed by a corresponding set of computer instructions stored in a memory 603 of the control panel 119, the results of the processor's computing may be indicated on a control panel face 700 and be sent to an interface 801 via a transmitter 611.

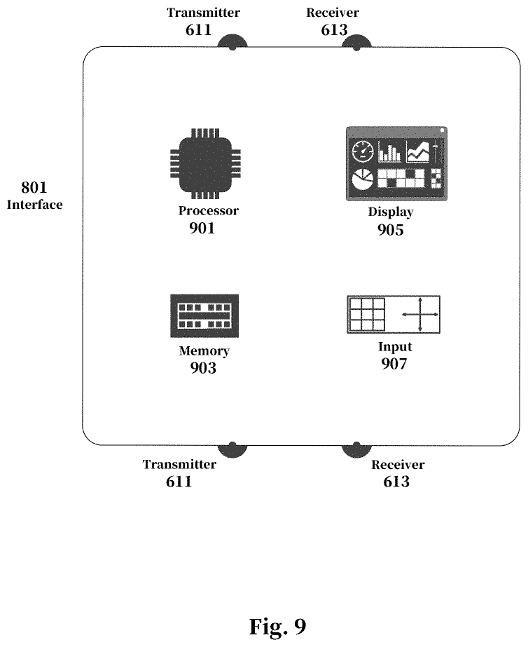

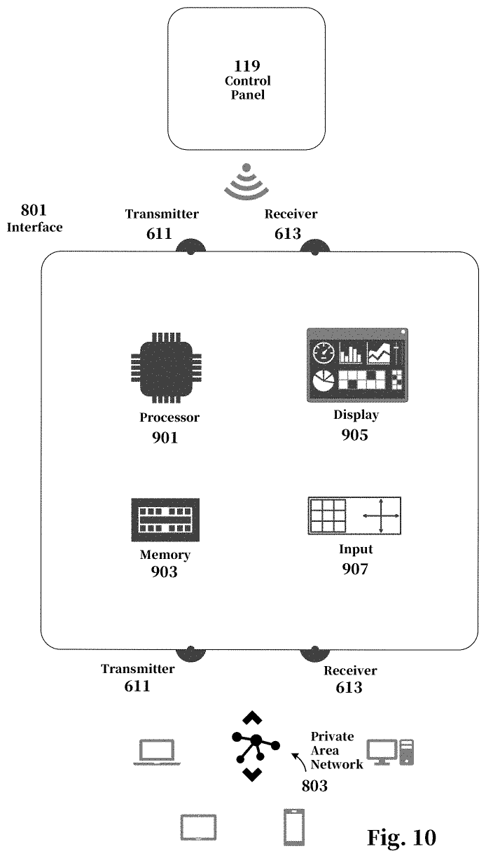

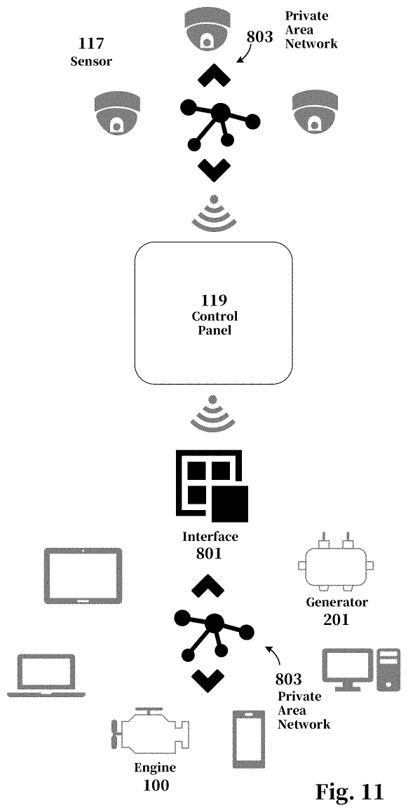

Turning now to FIGS. 9, 10, 11, further exemplary embodiments of a multi gas sensor system via an interface 801 and private area network 803 may be shown and described. It may be appreciated in this embodiment, as well as other embodiments described herein, that the gas sensing system may be implemented in a wireless or substantially wireless manner. For example, the interface 801 may be mounted in a desired or appropriate location on or associated with a vehicle, boat, or other location, for example, associated with an engine 100. Alternatively, in other exemplary embodiments, the interface 801 may be associated with software and/or a software application (or “app”), which can be viewed on a mobile phone, tablet, computer, or the like. Further, data communication and transmission between the interface 100 and any associated sensors 117 may be made in a wired or wireless fashion, for example over a private area network (“PAN”) 803 utilizing Zigbee, or via any secure communication protocol, as desired. Such systems may be secure and prevent against undesired or unauthorized access, such as hacking. Further, it may be appreciated that a system utilizing wireless technology may be operated in substantially the same manner as the wired system described in the above exemplary embodiments utilizing wired technology. In still other exemplary embodiments, it may be appreciated that other data transmitting and receiving protocols may be used, such as cellular or mobile data, wide area networks, and the like.

Still referring to exemplary FIGS. 9, 10, 11, it may be appreciated that the multi gas sensor 117 system described herein may also be utilized in residential and commercial environments. In such applications, a gas sensor 117 may be deployed in a desired area, such as a garage, and a viewable interface may be located remotely in a desired location or a software application that provide an interface 801 on a smart phone or tablet, for example, may be utilized.

Further, such systems as shown in exemplary FIGS. 9, 10, 11, may utilize wireless smoke and/or carbon monoxide sensors 117, utilize small enclosures with relays that can provide wireless start/run signals, may run off of 12V DC and/or have a backup connected to another power source, such as that associated with a starter 113 of an engine 100 to be monitored. The monitoring provided by the exemplary system can include gasoline fume monitoring, smoke monitoring, carbon monoxide monitoring, other carbon-based gas monitoring situation or event reporting through visual indicator 605 of a control panel face 700 or a display 905 of an interface 801 as well as audio indicia via audible indicator 609 or speakers mounted with or otherwise associated with the control panel 119 or a display 905 of an interface 801. As described in the above embodiments, the sensing of undesired levels related to such sensing may prevent the starting of an engine or stop a running engine, thus preventing various dangerous or hazardous situations. Further, once a situation is detected, that information may be displayed or otherwise provided via an interface as well as provide potential action, advice, guidance, or suggestions for mitigating the sensed situation. Further, the system may be activated through mechanical or electrical triggers, audio triggers, or remote access triggers associated with the control panel 119's input 607 and the interface 801's input 907. The system may further be integrated with or used in conjunction with other automation or home automation technologies, such as Nest® or Amazon Alexa®, as desired. Further, it is envisioned that in addition, or as an alternative to the above-described power sources, the system may include extended battery power that may provide a long life before servicing, replacement, or recharging. Additionally, other integrated technologies, such as remote engine start capabilities, are envisioned as being integrated or integratable into the system.

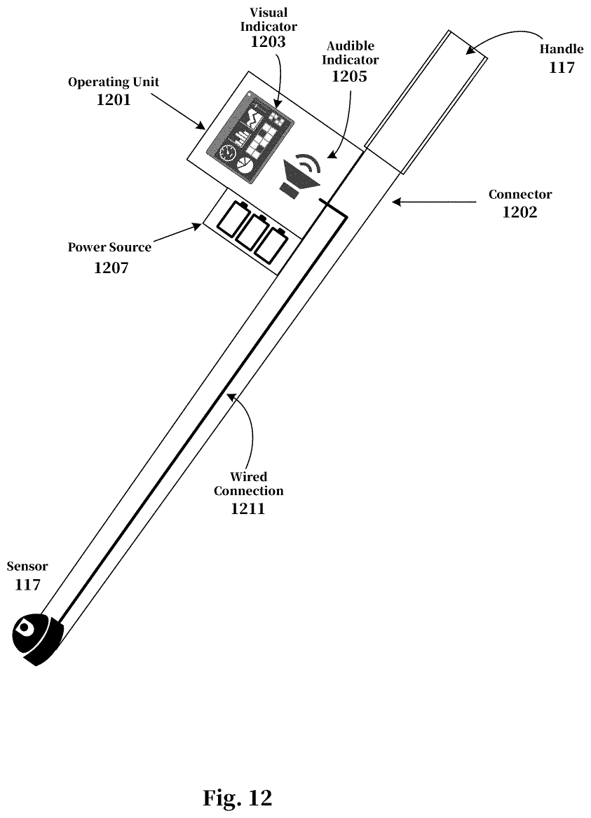

Turning now to exemplary FIG. 12, an exemplary schematic diagram of a portable instrument for monitoring engine conditions may be shown and described. According to an exemplary embodiment, the system for portable instrument for monitoring engine conditions may be configured to have an operating unit 1201 which is energized by a power source 1207 is connected to sensor 117 by a connector 1202. Additionally, the connector 1202 may be a tubular pole interiorly containing a wired connection 1211 between the operating unit 1201 and the sensor 117. Further, when the sensor 117 detects undesired gas, the detection may be indicated by a visual indicator 1203 and an audible indicator 1205 which are arranged on the operating unit 1201. For example, if the sensor 117 detects gasoline fume in 25% combustion levels and/or the lower explosion limits, the sensor 117 may send a signal to the operating unit 1201. The system may allow a user to perform a detection check with or without vehicle owner's knowledge, as it may be used without boarding the vehicle. Furthermore, the connector 1202 may include a handle 117 that may be used by a user to hold the system.

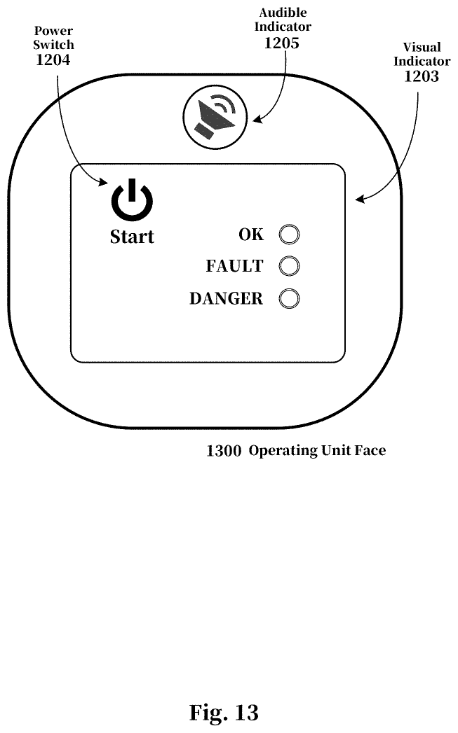

Turning now to exemplary FIG. 13, an exemplary schematic diagram of an operating unit's face may be shown and described. According to an exemplary embodiment, an operating unit's face 1300 may include a visual indicator 1203, an audible indicator 1205, and a power switch 1204 which may turn on or off the system. Particularly, the visual indicator 1203 and the audible indicator 1205 may show the states of a sensor 117. For example, if the sensor 117 is disconnected from the operating unit 1201, a “FAULT” LED may illuminate, or if the sensor 117 detects undesirable gas, a “DANGER” LED may illuminate.

In still further exemplary embodiments, the system can include a small current transformer that can provide an alarm when electric current leakage is detected on the load side of shore power. As is common in older boats and other vehicles/engines, ground faults can exist which can lead to undesired stray current situations. Thus, the system may be able to monitor, for example, electric water heaters, battery charges, and neutral-to-ground bonds at a point on vehicle or other electrical circuitry and provide appropriate warnings via an interface 801. In another exemplary embodiment, the system may be used in an enterprise fashion, for example monitoring all boats or vehicles in a marina or otherwise parked in a defined area. Such a system may be substantially implemented as above, but add the capability of monitoring any desired number of boats, vehicles, engines, etc.

In additional exemplary embodiments, the system and an interface may provide monitoring capabilities for any other engine performance or fluid elements. For example, if older gauges become inoperable and would be difficult to replace or impossible to replicate due to a boat s age, the system and an interface 801 can provide appropriate gauges and readouts, as desired. For example, with various sensors integrated into the system, and communicating via a private area network 803, the system can provide desired monitoring of any engine element traditionally shown on a gauge. These elements can include, but are not limited to, engine speed, battery status, water depth, various engine temperatures, fuel tank levels, sewage tank levels, potable water levels, water depth, window sensors, door sensors, motion sensors, etc. Sensors 117 may be employed with extended life batteries that allow them to act as endpoints that communicate, via private area network 803, with a main interface 801 and associated coordinator or router. Further, it is envisioned that a central interface device, or a mobile phone device, may communicate with any number of deployed sensors 117. Thus, the system can be viewed as modular and capable of modification to provide more or less sensing and monitoring capabilities as desired or as needed.

Still further exemplary embodiments may allow the system to act as a controller or control panel 119. For example, lighting controls, entertainment system controls, and other engine or vehicle controls may be integrated, as desired.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A system for monitoring engine conditions, comprising:
at least one power controller having a first electronical connection to a first power source;
at least one starter controller having a second electronical connection to at least one starter;
at least one sensor detecting at least one of gas and liquid in or proximate an engine; and
a control panel.

2. The system of claim 1, wherein the at least one power controller switches the first electronical connection to a second power source in response that the first power source is unavailable.

3. The system of claim 1, wherein the at least one power controller includes at least one power source indicator to show a type of power source to which the at least one power controller is connected.

4. The system of claim 1, wherein the at least one sensor sends a signal to the at least one starter controller in response that the at least one sensor detects a level of the at least one of the gas and the liquid reaches to a predetermined threshold.

5. The system of claim 4, wherein the at least one starter controller opens the second electronical connection to the at least one starter in response to receiving the signal sent by the at least one sensor, and the at least one starter controller includes a bypass to manually close the second electronical connection to the at least one starter.

6. The system of claim 4, wherein the control panel comprises:
at least one processor;
at least one memory being operably connected to the at least one processor;
at least one transmitter;
at least one receiver; and
at least one display,
wherein the at least one transmitter and the at least one receiver are wired or wirelessly connected to the at least one sensor; and
wherein the at least one processor is configured to indicate a warning on the at least one display.

7. The system of claim 6, wherein the at least one processor of the control panel, in response to receiving the signal sent by the at least one sensor, shuts down at least one producer which causes the at least one sensor to send the signal, and the at least one producer includes the monitored engine.

8. The system of claim 1, further comprising an interface, wherein the interface includes:
at least one processor;
at least one memory being operably connected to the at least one processor;
at least one transmitter;
at least one receiver; and
at least one display,
wherein the at least one transmitter and the at least one receiver are wired or wirelessly connected to the control panel via at least one mesh network, and
wherein the at least one processor is configured to receive data from the control panel and indicate the data on the at least one display.

9. The system of claim 1, further comprising at least one mesh network, wherein the at least one mesh network makes wired or wireless connections between the at least one sensor and the control panel.

10. A method for monitoring engine conditions, comprising:
having a first electronical connection, by at least one power controller, to a first power source;
having a second electronical connection, by at least one starter controller, to at least one starter;
detecting at least one of gas and liquid by at least one sensor; and
displaying, by a control panel, the detecting of the at least one sensor.

11. The method of claim 10, further comprises switching, by the at least one power controller, the first electronical connection to a second power source if the first power source is unavailable.

12. The method of claim 10, wherein the at least one power controller includes at least one power source indicator to show a type of power source to which the at least one power controller is connected.

13. The method of claim 10, wherein the at least one sensor sends a signal to the at least one starter controller in response that the at least one sensor detects a level of the at least one of the gas and the liquid reaches to a predetermined threshold.

14. The method of claim 13, wherein the at least one starter controller opens the second electronical connection to the at least one starter in response to receiving the signal sent by the at least one sensor, and the at least one starter controller includes a bypass to manually close the second electronical connection to the at least one starter.

15. The method of claim 13, wherein the control panel includes at least one processor, at least one memory being operably connected to the at least one processor, at least one transmitter, at least one receiver and at least one display, the at least one transmitter and the at least one receiver are wired or wirelessly connected to the at least one sensor, and the at least one processor is configured to indicate a warning on the at least one display.

16. The method of claim 15, wherein the at least one processor of the control panel, in response to receiving the signal sent by the at least one sensor, shuts down at least one producer which causes the at least one sensor to send the signal, and the at least one producer includes an engine.

17. The method of claim 10, wherein the control panel communicates with an external interface, the interface includes, at least one processor, at least one transmitter, at least one receiver and at least one display, wherein the at least one transmitter and the at least one receiver are wired or wirelessly connected to the control panel via at least one mesh network, and wherein the at least one processor receives data from the control panel and indicate the data on the at least one display.

18. The method of claim 10, wherein the at least one sensor and the control panel are wired or wirelessly connected via at least one mesh network.

19. A portable device for monitoring engine conditions, comprising:
a sensor detecting at least one of gas and liquid;
an operating unit having a visual indicator and an audible indicator;
a power source supplying a power to the sensor and the operating unit; and
a connector operably connecting the sensor and the operating unit.

20. The device of claim 19, wherein the operating unit is configured to indicate by at least one of the visual indicator and the audible indicator at least one of states of the sensor and a loss of the power supply.
